(19) United States
(12) Patent Application Publication
(10) Pub. No.: US 2013/0092523 A1
(43) Pub. Date: Apr. 18, 2013

(54) EVAPORATOR WITH COATED AND CORRUGATED TUBES

(71) Applicants: Amnon Levy, Ramat HaSharon (IL); Joseph Weinberg, Netanya (IL); Henrikh Rojanskiy, Or Akiva (IL)

(72) Inventors: Amnon Levy, Ramat HaSharon (IL); Joseph Weinberg, Netanya (IL); Henrikh Rojanskiy, Or Akiva (IL)

(73) Assignee: I.D.E. TECHNOLOGIES LTD., Kadima (IL)

(21) Appl. No.: 13/805,385

(22) PCT Filed: Jun. 20, 2011
(86) PCT No.: PCT/IB2011/052684

§ 371 Date: Dec. 19, 2012

(30) Foreign Application Priority Data
Jun. 22, 2010 (IL) 206540
Mar. 17, 2011 (GB) 1104465.8

(51) Int. Cl. C02F 1/08

(52) U.S. Cl. CPC C02F 1/08
USPC 203/89; 202/236

(57) ABSTRACT

An evaporator having more efficient heat transfer tubes, that are either or both coated and vertically corrugated. The coating, though reducing the heat transfer co-efficient, lengthens the time between cleaning treatment to increase the overall efficiency of the evaporator. The corrugation of the tubes controls the film characteristics and enhances evaporation from the film upon condensation of vapor within the tubes. The corrugation profile is selected to enhance waviness and turbulence of the films and thereby increase evaporation and condensation and hence the effectivity of the evaporator.

### BACKGROUND

1. Technical Field

The present invention relates to the field of desalination, and more particularly, to evaporator tubes.

2. Discussion of Related Art

Desalination of water is a process in which various soluble materials such as salt, contaminants, etc, are removed from water containing these materials, leaving clean, usually potable water. It is known that among most efficient thermal desalination processes currently in use are multi effect distillation (MED) and mechanical vapor compression desalination (MVC).

FIG. 1A is a schematic illustration of a multi-effect evaporator 100 with round tubes 110, according to the prior art, as disclosed, for example in European patent document No. 1858609. Existing Multi Effect Desalination plants 100 utilize aluminum alloy horizontal tubes 110, falling-film evaporative condensers in a serial arrangement, to produce through repetitive steps of evaporation and condensation, each at a lower temperature and pressure, a multiple quantity of distillate from a given quantity of input vapor. Feed 90A entering each effect 101 is introduced as a thin falling film 90 onto outer surface 114 (see FIGS. 2, 5A) which is supported externally by tubes 110. Vapor 85A flows internally through tubes 110 in inner space 147, delimited by inner surface 116 (see FIGS. 2 and 5B). As vapor 85A condenses, feed 90A from film 90 evaporates and the vapor is introduced into tubes 110 of next effect 101. Condensate 81 is collected from tubes 110, while brine 82 is collected from film 90 after flowing over all tubes 110. Prior art tubes 110 are circular.

Any number of evaporative condensers (effects 101) may be incorporated in the plants' heat recovery sections, depending on the temperature and costs of the available low grade heat and the optimal trade-off point between investment and vapor economy. Technically, the number of effects 101 is limited only by the temperature difference between the vapor 85A and seawater 90A inlet temperatures (defining the hot and cold ends of the unit) and the minimum temperature differential allowed on each effect 101.

The incoming seawater 90A is de-aerated and preheated in the heat rejection condenser and then divided into two streams One is returned to the sea as coolant discharge, and the other becomes feed for the distillation process. Feed 90A is pretreated with a scale inhibitor and introduced into the lowest temperature group. The introduction to the lowest temperature group (backward feed flow) rather than to the highest is due to an effort to maintain the thermodynamic efficiency of the plant by reducing the irreversible mixing of the colder seawater feed with the hot effects temperature. Due to the falling film 90 nature of the feed flow over tubes 110 a pump is required to move the saline water from the bottom of the effect 101 to the top of the next one 101.

Input vapor 85A is fed into tubes 110 of the hottest effect. There it condenses, giving up its latent heat to the saline water flowing over the outer surface of tubes 110, while condensation takes place on the inside of tube 110, a nearly equal amount of evaporation occurs on the outside minus the amount required to preheat the feed to the evaporation temperature. The evaporation-condensation process is repeated along the entire series of effects, each of which contributes an amount of additional distillate. The vapor from the last effect is condensed by seawater coolant in the heat rejection condenser.

FIG. 1B is a schematic illustration of a mechanical vapor compression desalination apparatus (MVC) with round tubes 110, according to the prior art. MVC comprises an evaporator 100 receiving sea water feed 90A that is pre-heated by exchanging heat with exiting product 81 and brine 82 in a heat exchanger 87 and in a condenser 88. Water 90 is consecutively introduced as a falling film upon tubes 110 one effect 101 after the other. In each effect 101 the falling film is produced by residual water from the former effect, while vapor from the former effect condenses within tubes 110. Vapor is removed and compressed by a compressor 86 to be reintroduced into the first effect. Condensate 81 and residual brine 82 are then removed from evaporator 100. Tubes 110 are the heat exchanger in evaporator 100, and their heat transfer coefficient and susceptibility to scaling determine the overall efficiency of the MVC.

The MVC process is based on the application of the principle of a heat pump, which continuously recycles and keeps the latent heat exchanged in the evaporation-condensation process within the system, instead of using steam for effecting the evaporation as in MED systems. The evaporation-condensation process takes place in equipment similar to that used in the MED process. Tubes utilized in the evaporators in MED and MVC processes are usually made of aluminum alloys, which have high heat transfer coefficients required for the MED and MVC processes, allowing to keep the evaporators' size as small as possible, i.e. the higher the heat transfer coefficients, the smaller the size of the evaporator. Due to high temperatures at which the aluminum alloy tubes are used in the above systems and salt and contaminants in the water to be desalinated, the quality of these tubes surface which is in contact with the water deteriorates in time as a result of corrosion and scale precipitation, reducing thereby the heat transfer coefficients. When the corrosion and scaling reach certain predetermined levels, cleaning of the tubes is required. In particular, in MED and MVC systems, the tubes are normally cleaned when the reduction of their heat transfer coefficient reaches approximately 10% from its original value.

### BRIEF SUMMARY

One aspect of the invention provides an evaporator comprising a plurality of tubes arranged to support a vertical film of saline water, and to evaporate water from the film by heat transfer from a condensate film of condensing vapor within the tubes, the tubes having a heat transfer coefficient h_{O} that deteriorates to a heat transfer coefficient hₘ as a result of scaling, wherein reaching hₘ requires cleaning the tubes from the scaling after a period T_{O}, the evaporator characterized in that the tubes comprise an outer coating having a heat transfer coefficient h_{C} larger than hₘ and smaller h_{O}, the outer coating selected to increase a cleaning period to T_{C} larger than T_{O}.

Another aspect of the invention provides an evaporator comprising a plurality of horizontal, vertically elongated tubes arranged to support a vertical film of saline water, and to evaporate water from the film by heat transfer from a condensate film of condensing vapor within the tubes, characterized in that: the horizontal tubes are vertically and circumferentially corrugated in at least a specified outer profile comprising alternating outer ridges and grooves on an outer face of the tubes, the specified outer profile selected to thin the film on the outer ridges to enhance heat transfer therethrough and evaporation therefrom.

This, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

The present invention will be more readily understood from the detailed description of embodiments thereof made in conjunction with the accompanying drawings of which:

FIG. 2 is a cross-sectional view of one example of a round heat transfer tube that can be used in MED (FIG. 1A) and MVC (FIG. 1B), according to some embodiments of the invention,

FIG. 3 is a cross-sectional view of a coated oval heat transfer tube used in MED and MVC, according to some embodiments of the invention,

FIG. 4 is an external perspective view of an oval corrugated heat transfer tube, according to some embodiments of the invention,

FIGS. 5A-5D are schematic illustrations of a corrugated and vertically elongated tube, according to some embodiments of the invention;

FIGS. 6A-6I are schematic illustrations of the corrugation form on the tubes and its production, according to some embodiments of the invention; and

FIG. 7 is a high level schematic flowchart illustrating a method of enhancing heat transfer across evaporator tubes, according to some embodiments of the invention.

### DETAILED DESCRIPTION

Prior to setting forth the detailed description, it may be helpful to set forth definitions of certain terms that will be used hereinafter.

The term “corrugate” as used herein in this application, is defined as a sequence of parallel and alternating ridges and grooves, or flutes. The ridges and grooves (or flutes) are on both sides of the corrugated surface. The direction of grooves, or flutes 124 (see below) on tubes 110 may be vertical, or grooves 124 may be diagonal in respect to the faces of tube 110. The term corrugated tubes is not to be taken as limiting the relative angle of the ridges and grooves in respect to the tubes' faces.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. When heat transfer elements such as heat transfer tubes 110, are made of a light metal or light metal alloy, their heat transfer surfaces 114, 116 (hereinafter: ‘metal heat transfer surfaces) when put under the process conditions, undergo corrosion and/or scale precipitation.

During a certain period of time, the corrosion and scale precipitation reduce heat transfer coefficients of the metal heat transfer surfaces, and if no cleaning thereof is performed (by cleaning treatment), the desalination rate can be substantially decrease. Thus, in a desalination process, whether performed by MED, MVC, or by any other desalination system, where heat transfer tubes 110 are conventionally made of a light metal or light metal alloy. Tubes 110 have an original heat transfer coefficient ho at their metal heat transfer surface, and a minimal acceptable value hₘ of the heat transfer coefficient at which cleaning of the metal heat transfer surface from corrosion and/or precipitated scale is performed. Under predetermined process conditions, it is normally known how long it will take the heat transfer coefficient to reach its minimal acceptable value and the system needs to undergo a cleaning treatment. Every such time the operation of the system has to be temporary terminated for the cleaning. Depending on the quality of water at different sites, it may take the system different time T_{O} during which the above acceptable minimal value hₘ of the heat transfer coefficient is reached.

Often, the acceptable difference between the original and minimal values of the heat transfer coefficient (h_{O}−hₘ) is no more than 10% from the original heat transfer coefficient h_{O}.

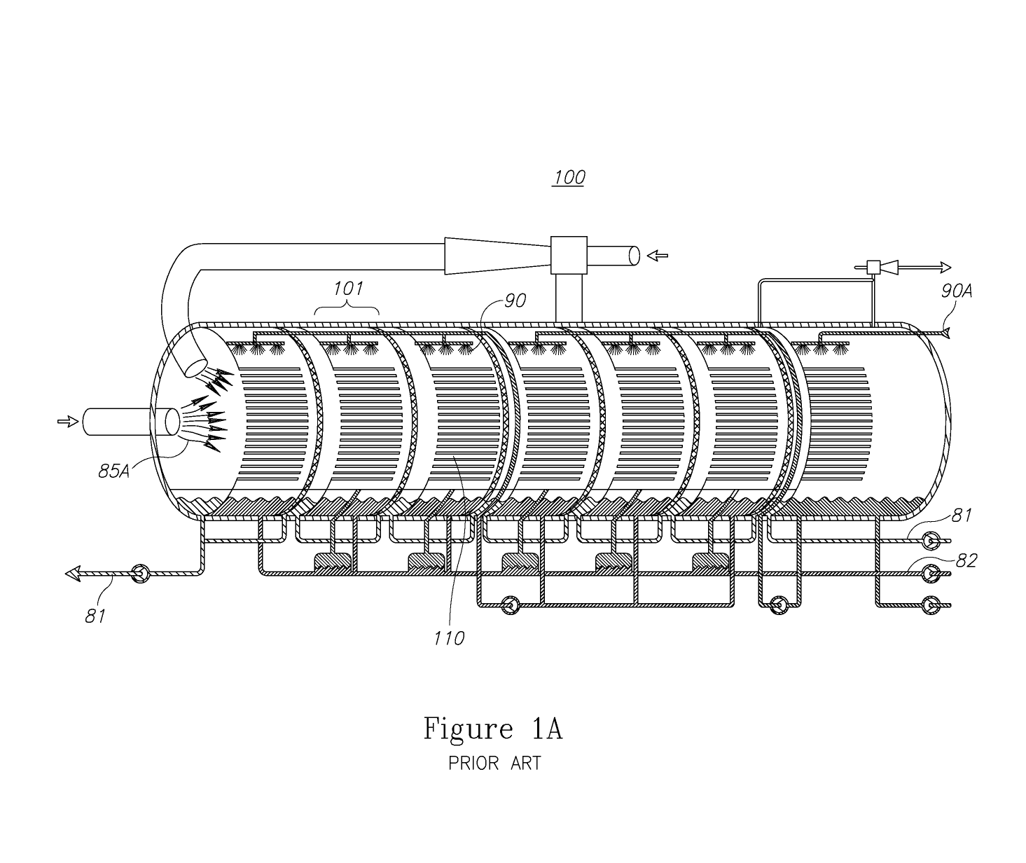

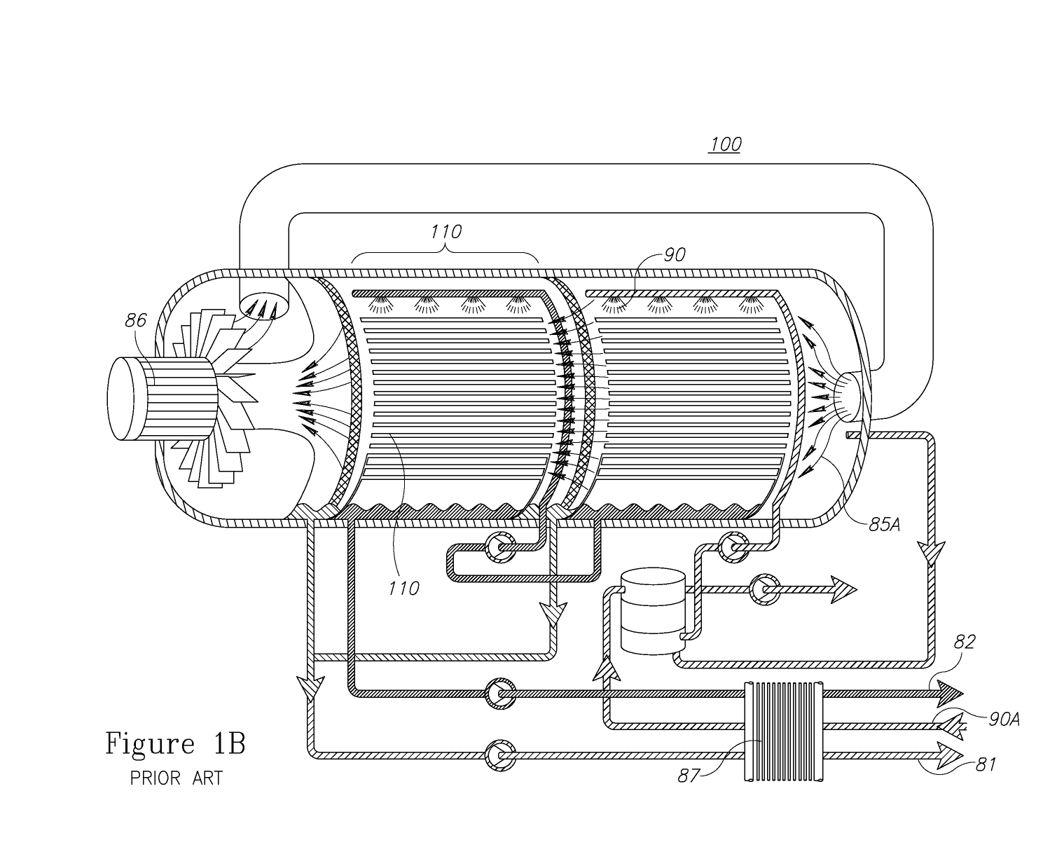

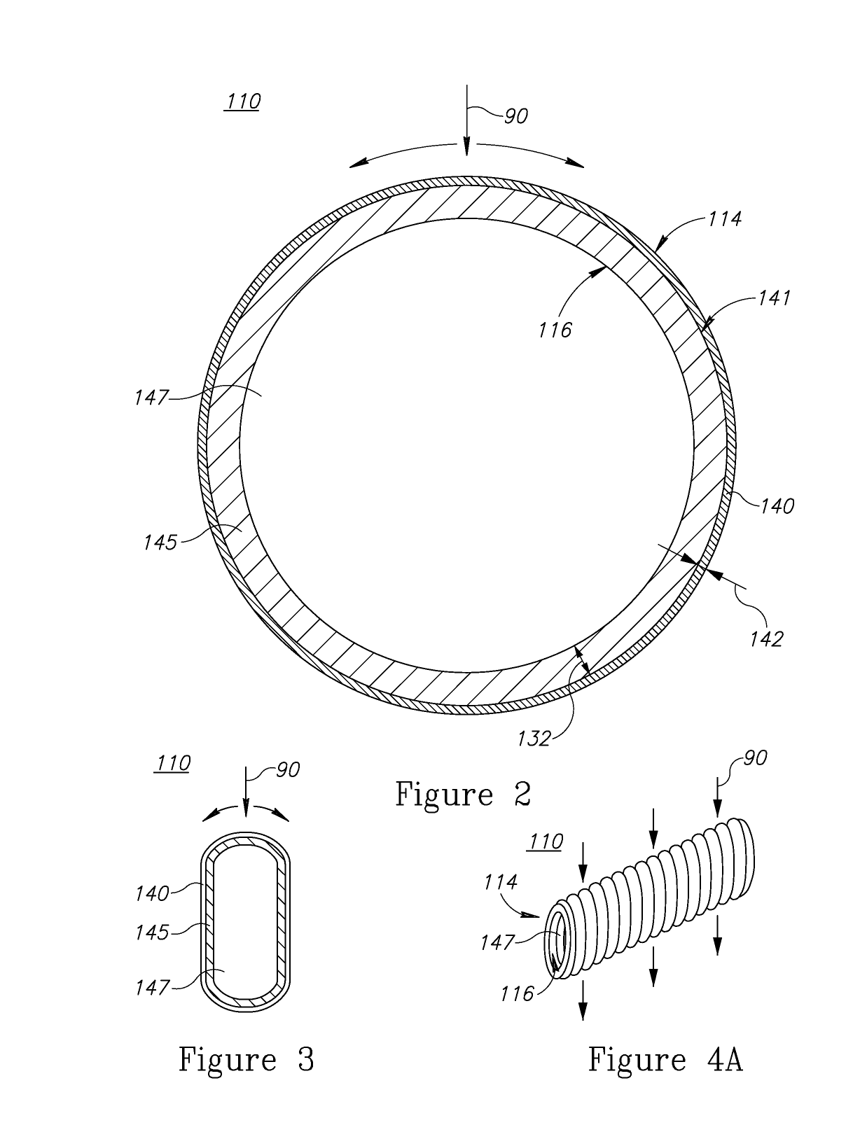

FIG. 2 is a cross-sectional view of one example of round heat transfer tube 110 that can be used in MED (FIG. 1A) and MVC (FIG. 1B), according to some embodiments of the invention. Tube 110 comprises an outer surface 141 on which coating 140 is deposited, an inner surface 116, and a wall 145 extending between surfaces 141 and 116, which constitutes the tube material.

Outer surface 141 of tube 110 may be coated by a coating 140, such as a ceramic protecting layer with a coating outer surface 114 being tube 110's outer face.

Heat transfer tube 110 may be made of a light metal or a light metal alloy, such as aluminum or magnesium alloys (e.g. 3XXX and 5XXX series aluminum alloys), and in a desalination process, outer surface 114 functions as the original (i.e. without coating 140) tube outer heat transfer surface 141 (hereinafter: ‘metal heat transfer surface’).

Coating 140, such as the ceramic protecting layer on metal outer heat transfer surface 141 may comprise, fully or partially, an oxide of the metal of which tube 110 is made, obtained by oxidization treatment of the surface 141.

Various processes may be used for forming coating 140 or the ceramic protecting layer. Examples of such processes are anodization and plasma electrolytic oxidation which is also known as micro arc oxidation (MAO), the latter being a more advanced process for producing higher quality coatings. Both of the aforementioned processes are electrochemical surface treatment processes for generating oxide coatings on metals, MAO is a process that employs higher potentials than anodizing, causing discharges to occur in the oxide layer that is being formed, wherein the resulting plasma modifies and enhances the structure of the oxide layer.

Alternatively, the coating can be deposited onto the surface, e.g. by the process of thermal spraying (e.g. plasma spraying) or by the process of electrodeposition (also known as electroplating). For example, a deposited ceramic protecting layer 140 may comprise zirconia and/or other oxides typically used to produce ceramic coating layers.

Ceramic protecting layer 140 may be formed by a number of separate ceramic coating layers comprising different materials and having different properties. A combination of the aforementioned processes can also be used to produce ceramic protecting layer 140.

With coating 140 as described above, outer surface 114 functions, in a desalination process, as a ceramic layer heat transfer surface (hereinafter: ‘ceramic heat transfer surface’).

Wall 145 of heat transfer tube 110 is of a thickness 132, and coating 140 is of a thickness 142, which is essentially less than thickness 132 of tube 110. In particular, wall thickness 142 may be between 5% and 0.5% of coating thickness 142.

For example, with tube 110 described above being made of aluminum alloy 5052, with thickness 132 of tube's wall 145 being in the range between 1 to 2 mm, ceramic protection layer 140 may have thickness 142 between 10 to 20 microns. Coating 140 may be formed e.g. by micro-arc oxidation and have a roughness average (i.e. surface finish)—Ra, in the approximate range of 0.5-2 microns.

Ceramic protecting layer 140 may be configured to ensure that the heat transfer coefficient of tube 110 at its ceramic heat transfer outer surface 114 has a value h_{C} that satisfies the condition hₘ<h_{C}<h_{O} under the predetermined process conditions referred to above. As a result of the formation of ceramic protecting layer 140 described above, tube 110 has a lower rate of corrosion and/or scale precipitation than that it would have without ceramic protecting layer 140, with metal surface 141 as outer surface 114.

With ceramic protecting layer 140 as described above, the time T_{C} during which the heat transfer coefficient h_{C} reaches its minimal acceptable value hₘ is longer than T_{O}—the time tube 110 reaches hₘ without layer 140. Hence, although coating 140 reduces the maximal (clean) heat transfer coefficient from h_{O} (for metal heat transfer surface 141 without coating 140) to h_{C}, it much more extends the duration between sequential cleaning of outer surface 114 from scale and corrosion from T_{O} to T_{C}, which both provides a higher average heat transfer coefficient during the operation period between sequential treatments (T_{C}) as well as reduces the frequency of necessary cleaning treatments which increases the overall desalination efficiency.

For example, instead of cleaning the desalination system once a year (T_{O}) which is a standard cleaning frequency for multi-effect systems, it can be cleaned once in two years (T_{C}).

FIG. 3 is a cross-sectional view of a coated oval heat transfer tube 110 used in MED and MVC, according to some embodiments of the invention, and FIG. 4 is an external perspective view of an oval corrugated heat transfer tube 110, according to some embodiments of the invention.

While FIG. 2 illustrates a round tube 110, FIG. 3 illustrates an oval, or vertically elongated cross section of tube 110, and FIG. 4 illustrates a vertically elongated cross section of tube 110 with vertical corrugations of outer surface 114, that may but not must be coated with coating 140, and further enhance heat transfer across tube 110.

Arrows mark the direction of water 90 that is sprayed onto surface 114 of tube 110. A ceramic protecting layer 140 may be applied to at least some portion of surface 114 of tube 110, which serve as heat transfer surfaces, in order to reduce the rate of corrosion and/or scale precipitation thereon.

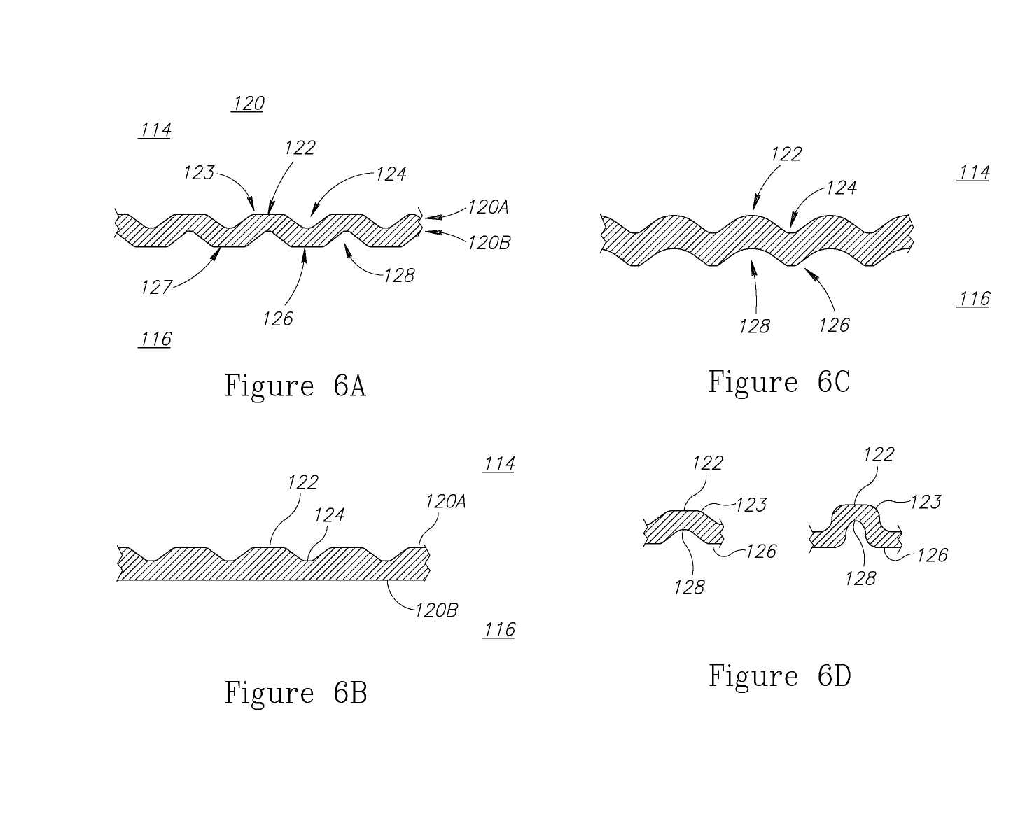

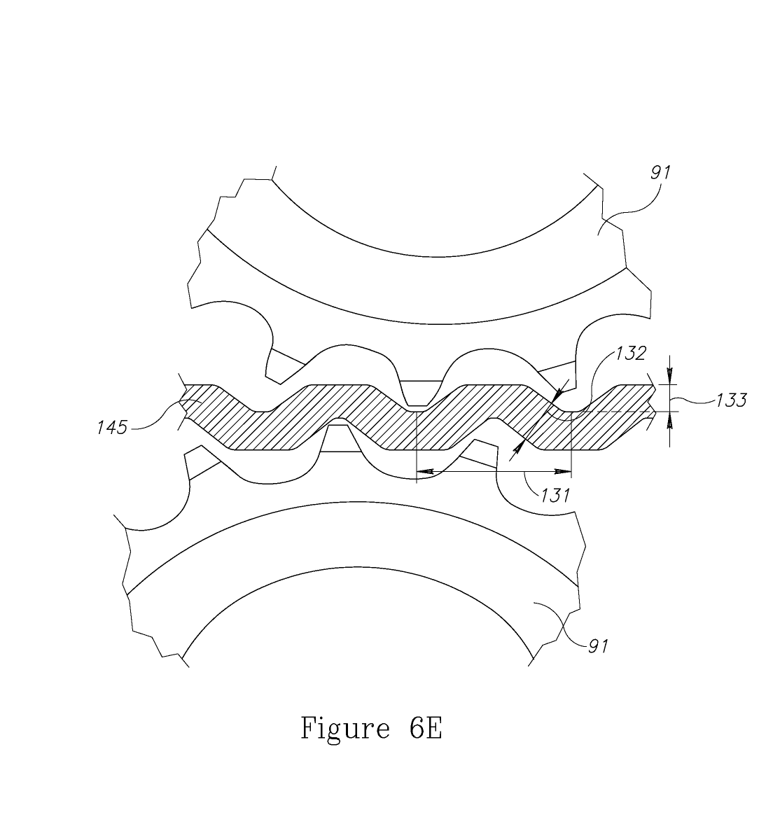

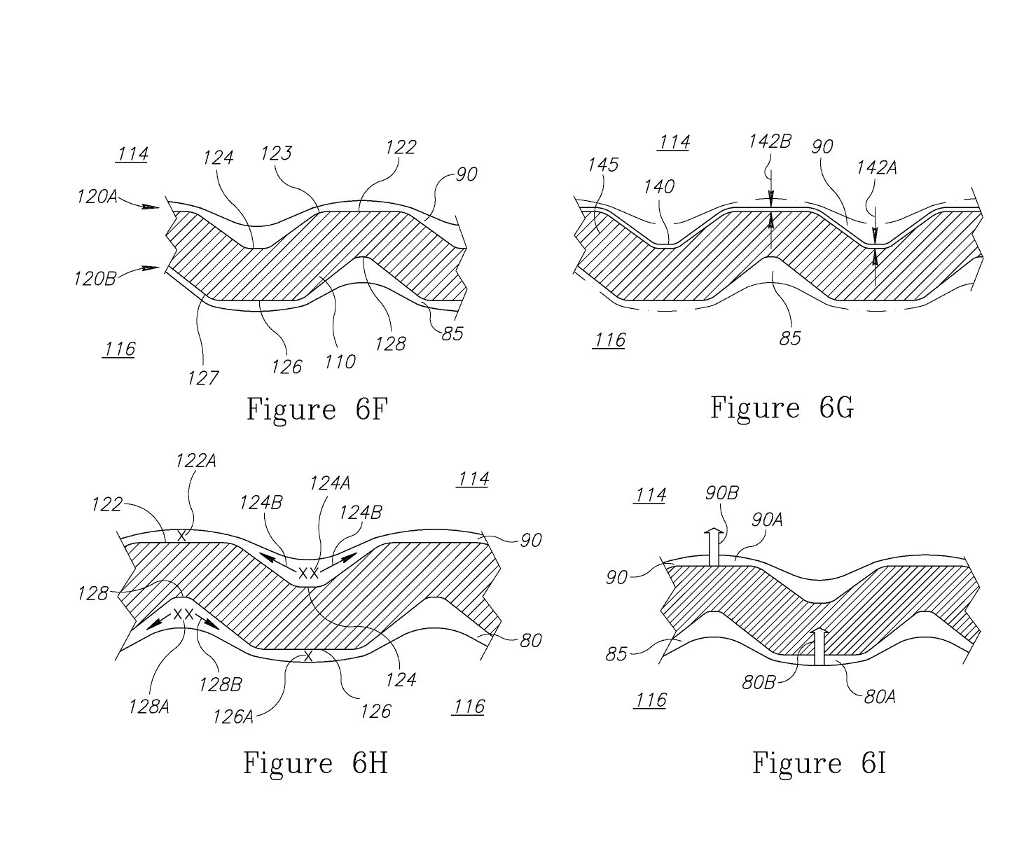

In the corrugated embodiments (FIGS. 4, 5D, 6I) coating 140 may be deposited onto the corrugations, e.g. only on outer surface 114 (possibly also on inner surface 116). Coating thickness 142A, 142B may vary across the corrugations, e.g. vary between outer ridges 122 and outer grooves 124 of outer surface 114 (see FIG. 6I). Coating thicknesses 142A, 142B may be calculated to maximize heat transfer and maximize cleaning intervals at their operating conditions and in respect to water film flow as explained below (FIGS. 6F-6H). The inventors submit that increasing overall heat transfer and heat transfer efficiency by coating heat transfer tubes 110 with ceramic coating 140 is a surprising result, as, in view of their extremely low thermal conductivity, such coatings have not been used on elements whose functioning required their high thermal conductivity, such as elements used in desalination processes. On the contrary, it was rather suggested to use the above coatings as thermal barrier layers (J. A. Curran and I. W. Clyne, The Thermal Conductivity of Plasma Electrolytic Oxide Coatings on Aluminum and Magnesium, Surface and Coatings Technology, Volume 199, Issues 2-3, 22 Sep. 2005, Pages 177-183, Plasma Electrolysis).

The inventor of the subject matter of the present application has realized that, in spite of the reduced thermal conductivity, coating (protecting layer) 140 can be used on elements participating in a desalination process, to increase the time by which corrosion and/or scale precipitation on their metal heat transfer surface causes the heat transfer coefficient of said surface to reach its minimal acceptable value, if the coating is designed so that the changed heat transfer coefficient (h_{C}) is higher than the minimal acceptable heat transfer coefficient (hₘ). Heat transfer element 110 may be a tube having any desired cross-sectional shape, e.g. a circular or oval cross-sectional shape. Ceramic protecting layer 140 in such element can be disposed on outer surface 141 of the tube wall, i.e., facing the exterior of tube 110, and/or on an inner surface 116 of tube 110. Heat transfer element 110 can also be a heat exchanging plate, for example such as those used in the MVC evaporators.

Heat transfer surface 116 of heat transfer element 110 may be grooved or smooth. When grooved tubes 110 are oval, they can be formed in such manner that the grooves are oriented about 90° to the longitudinal axis of tubes 110 (e.g. vertically when tubes 110 are horizontal). The heat transfer surface or at least a portion thereof can also have a corrugated form. The grooves or corrugations increase the efficiency of the heat transfer.

Ceramic protecting layer 140 can comprise or be fully made of a light metal alloy oxide, such as an aluminum alloy or a magnesium alloy, in which case ceramic protecting layer 140 can comprise or be fully made of aluminum or magnesium oxide, respectively. Magnesium has the advantage of being lighter than aluminum, but is more sensitive to severe process conditions (such as high temperature, high solute concentration).

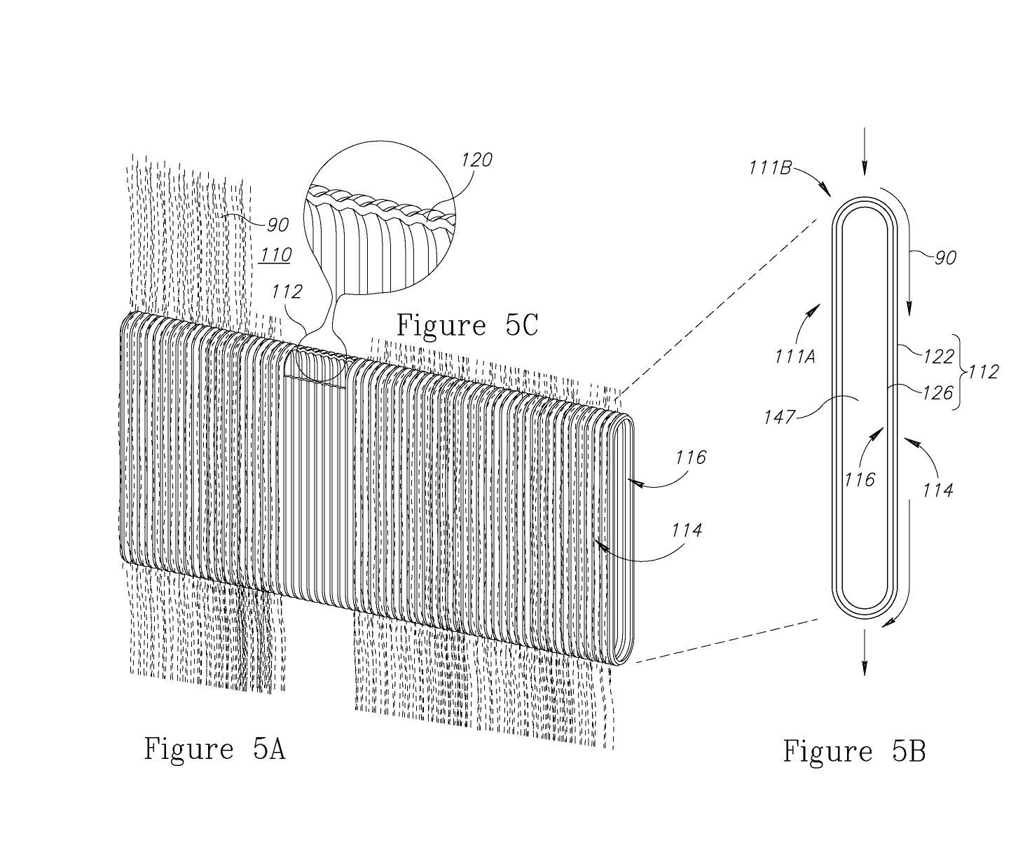

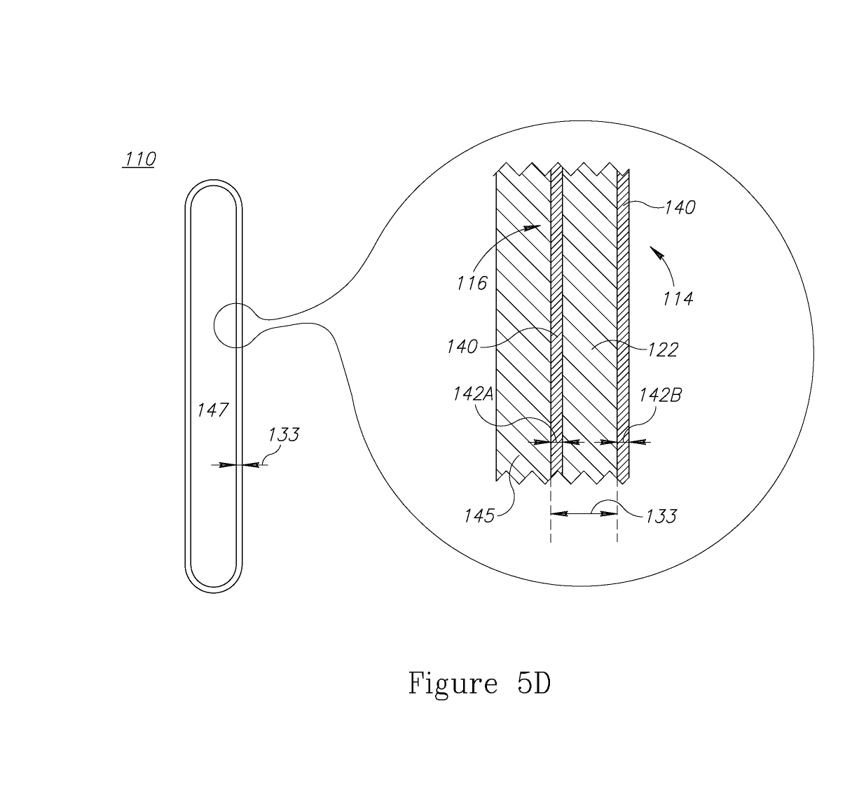

Heat transfer element 110 can constitute a part of desalination or chemical solution concentration system or a system used in evaporators, in particular industrial evaporators. FIGS. 5A-5D are schematic illustrations of a corrugated and vertically elongated tube 110, according to some embodiments of the invention; and FIGS. 6A-6I are schematic illustrations of a corrugation form 120 on tubes 110 and its production, according to some embodiments of the invention.

FIG. 5A is a perspective view of tube 110 with film 90 illustrated on a part of tube 110. Film 90 falls on all or most length of tube 110, and is shown only on a part of tube 110 for clarity reasons. FIG. 5B illustrates a transverse cross section of tube 110, FIG. 5C is a perspective view of a detail on the upper edge of tube 110 and FIG. 5D illustrates coated corrugated tube 110. FIGS. 6A-6D illustrate a longitudinal cross section through tube 110, presenting various corrugation forms 120, FIG. 6E illustrates the cross section in an exemplary production method, and FIGS. 6F-6I illustrate film 90 and condensing vapor 85 on the longitudinal cross section, and further illustrate the functioning of the corrugated tube wall profile with and without coating 140.

Multi effect evaporator 100 comprises effects 101, each with a plurality of horizontal tubes 110 arranged to support a vertical film 90 of saline water, and to evaporate water from film 90 by heat transfer from condensing vapor within tubes 110. Tubes 110 are vertically elongated to increase a contact area between tubes 110 and film 90, and to better support and control the form and thickness of film 90. The form of tubes 110 may be oval and may have vertical parallel sides 111A connected rounded ends 111B.

Tubes 110 are vertically and circumferentially (relating to a transverse cross section) corrugated 112 in a specified profile 120. Corrugation form 120 may be selected according to various criteria, including, for example heat transfer coefficients, thickness and waviness of film 90 and of condensate film 85, downwards flow speed of film 90 and of condensate film 85 in respect to a location on profile 120. Corrugation 112 is arranged to enhance heat transfer from the vapor to film 90 and further enhances water evaporation by determining film characteristics.

FIG. 5D presents an enlarge and exaggerated illustration of a transverse cross section through the edge of corrugated and coated tube 110. Outer ridges 122 and outer grooves 124 (see below, FIG. 6A) on outer face 114 of tubes 110 may be coated by coating 140 such as an oxide layer, that may have varying thickness on outer ridge 122 (thickness 142A) and outer groove 124 (thickness 142B). Thicknesses 142 of coating 140 are exaggerated in FIG. 5D.

Profile 120 comprises a specified outer profile 120A and a specified inner profile 120B (FIGS. 6A, 6F) that are selected to control the flowing characteristics, such as thickness and waviness, of film 90 and of condensate film 85, respectively, to enhance evaporation from an outer face 114 and condensation on an inner face 116 of tubes 110.

Specified outer profile 120A comprises outer ridges 122 and outer grooves 124 on outer face 114 of tubes 110, specified inner profile 120B comprises inner ridges 126 and inner grooves 128 on inner face 116. Outer grooves 124 correspond to inner ridges 126 and inner grooves 128 correspond to outer ridges 122. Outer profile 120A enhances evaporation (from outer ridges 122), while inner profile 120B enhances condensation of vapor (in inner grooves 128).

Specified outer ridge profile 120A may be congruent to specified inner ridge profile 120B, such that profile 120 is rotationally symmetric. The congruence may result from a symmetric production method of the sheets that are used to manufacture tubes 110. Corrugation 112 may be produced by two identical cogs 91, each arranged to produce a corresponding ridge profile 122, 126. Tubes 110 may be produced from planar corrugated sheets (see FIG. 6E), e.g. by bending and welding them to tubes 110. Tubes 110 may be produced in alternative ways, such as hydroforming, pressing, etc.

Specified outer ridge profile 120A and specified inner ridge profile 120B may be trapezoidal, with either straight or convex sides (FIG. 6B).

Outer ridges 122 and inner ridges 126 may have flat tops which are angular 123, 127 (respectively) on their sides. Alternatively, outer ridges 122 and inner ridges 126 may have convex tops which are angular 123, 127 (respectively) on their sides. Angled outer ridges 123 are shaped to control film characteristics. For example, angle 123 may be selected to promote evaporation from film 90 by thinning or breaking film 90 and enhancing film instability, as illustrated in FIG. 6F.

The form of tubes 110 influences film characteristics and may stretch and thin film 90 under operation of gravity, surface tension and flow forces (FIGS. 6F-6I). Outer ridges 122 may enhance the wavy character of falling film 90 on outer face 114 of tubes 110 and thereby enhance evaporation. Inner ridges 126 and inner grooves 128 may enhance the wavy character of falling condensate on inner face 116 of tubes 110 and thereby enhance condensation.

Corrugation 112 of both inner and outer faces 114, 116 allows optimizing surface characteristics that maximize evaporation and condensation, and thus maximize the process efficiency. In particular, generating stronger waviness, internal turbulence vortices inside the films 90 and condensate film, and shear forces on film 90.

The inventors have discovered, that corrugation 112 changes flow characteristics and improve heat transfer in some embodiments in the following manner (FIGS. 6H, 6I). Downwards flow of film 90 (on outer face 114) and/or condensate film 80 (on inner face 116) has a larger volume and a lower speed in grooves 124, 128 (flows 124A, 128A) than on ridges 122, 126 (flows 122A, 126A), all designation respective to outer face 114 and inner face 116. Due to the different flow speeds, the intermediate parts of the film flow with a horizontal component 124B, 128B that compensates the eater masses and generates waviness in films 90, 85, which enhances evaporation. As a result of surface tension forces, film 90, 85 on ridges 122, 126, denoted in FIG. 6I by 90A and 80A, are thinner and flow faster than without corrugation 112, and their thinness improves heat transfer (denoted by 90B and 80B in FIG. 6I respectively) from tube 110 across film 122A, 126A, and hence a stronger evaporation therefrom. Indeed in grooves 124, 128 heat transfer becomes somewhat worse, but overall, due to the larger area of the areas with a thinner film, heat transfer improves. These effects of the corrugation are much more significant on outer face 114 as the amount of water in film 90 are much larger than in film 80 (as film 90 is feed water, while film 80 is condensate).

In embodiments, outer face 114 of tube 110 may be coated (FIG. 6G), possibly in variable thickness 142A, 142B over profile 120, to reduce scaling and increase overall average heat transfer coefficient and/or maintenance periods in respect to uncoated corrugated tubes 110.

Alternatively, profile 120 may comprise only an outer corrugation (FIG. 6B) a wavy profile (FIG. 6C), which may also provide some of the presented benefits.

In embodiments, the inventors have discovered the following profile characteristics to be most effective in some cases. in profile 120, a horizontal distance between sequential grooves 131 is 3.2 times (±10%) a tube wall thickness 132, and a depth of the grooves 133 is a fifth (±10%) of the horizontal distance between sequential grooves 131. Tube wall thickness 132 may be between 0.7 and 1.6 mm. In embodiments, tube wall thickness 132 may be between 1 and 1.25 mm. Tubes 110 may be made of aluminum to enhance heat transfer properties.

Parts or all of tubes 110 may be coated by anti-corrosion coating 140 such as a ceramic coating. Inner face 116 may also be coated by an anti-corrosion coating (not shown). Coating 140 may be deposited on tubes 110 before or after their production from the sheets, in the latter case to protect strained areas of tubes 110. Thickness 142 of coating 140 may be between 10 to 20 microns with a roughness average between 0.5-2 microns. Coating 140 may be formed e.g. by micro-arc oxidation, anodization or other oxidative surface treatment methods.

The inventors have found, that overall in some embodiments, corrugated tubes 110 have a total heat transfer coefficient (evaporation and condensation) that is higher by a factor of 2.5 to 3.5 in respect to oval smooth tubes in the same hydraulic and thermodynamic conditions.

Evaporator 100 may further comprise a surfactant unit arranged to add a surface active agent to the saline water to control film 90 thickness on tubes 110. The surface active agent may enhance the waviness of film 90 and further enhance evaporation.

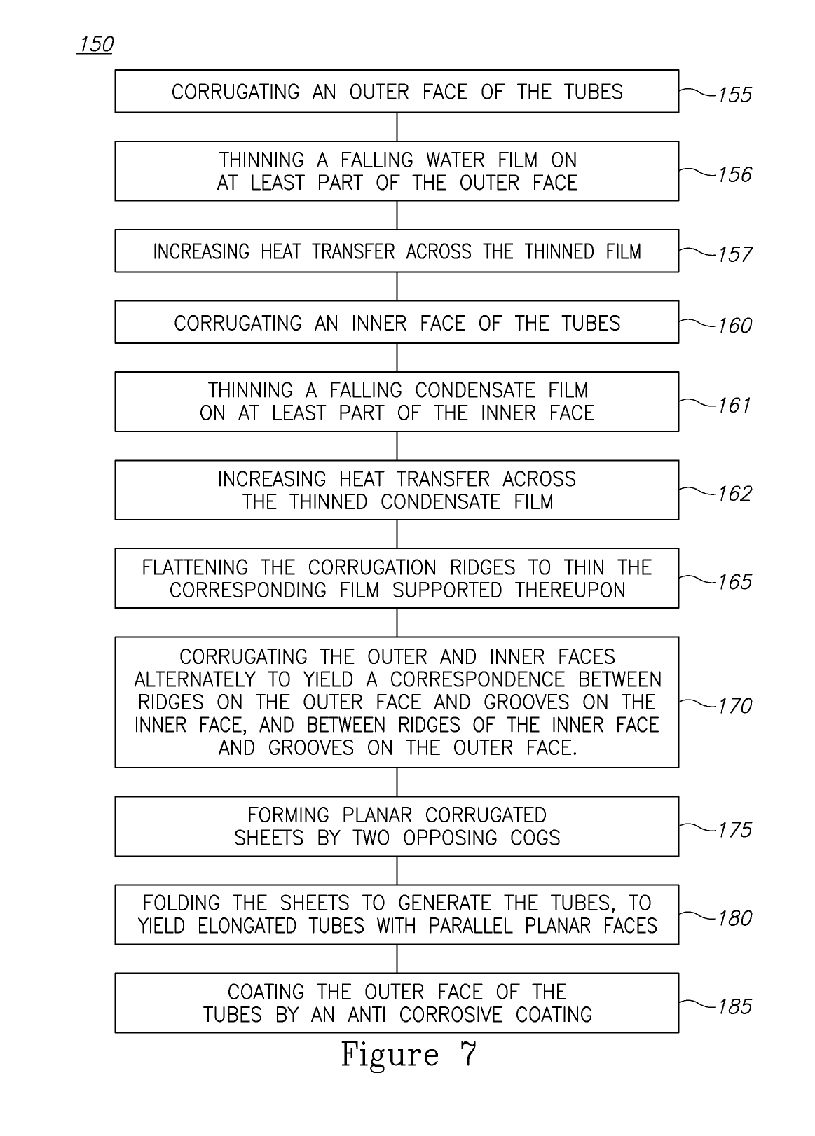

FIG. 7 is a high level schematic flowchart illustrating a method 150 of enhancing heat transfer across evaporator tubes, according to some embodiments of the invention. Method 150 comprises the following stages: corrugating (i.e. forming ridges and grooves) an outer face of the tubes (stage 155) to thin a falling water film on at least part of the outer face (stage 156), to increase heat transfer across the thinned film (stage 157), and optionally corrugating an inner face of the tubes (stage 160) to thin a falling condensate film on at least part of the inner face (stage 161), to increase heat transfer across the thinned condensate film (stage 162).

Method 150 may further comprise flattening the corrugation ridges (on either inner or outer faces, or both) to thin the corresponding film supported thereupon (stage 165). The corrugated ridges may be fully or partly flattened (to become either flat or convex) to create angled ridge edges.

Corrugating of the outer face and of the inner face (stage 155 and 160 respectively) may be carried out alternately (stage 170), to yield a correspondence between ridges on the outer face and grooves on the inner face, and between ridges of the inner face and grooves on the outer face.

For example, the alternate corrugation (stage 170) may be carried out by two opposing cogs to form planar corrugated sheets (stage 175), and method 150 may further comprise folding the sheets to generate the tubes, to yield elongated tubes with parallel planar faces (stage 180). The tubes may be formed by any other production method, such as hydroforming, pressing, etc.

The inventors have found out, that heat transfer efficiency was maximized in one case, by corrugating the tubes (stages 155, 160, 170) to yield a horizontal distance between sequential grooves that is 3.2 times (±10%) a tube wall thickness, and a depth of the grooves is a fifth (±10%) of the horizontal distance between sequential grooves.

Method 150 may further comprise coating the outer face of the tubes by an anti corrosive coating (stage 185), for example by oxidizing the outer surface of the tubes. The coating may have a heat transfer coefficient h_{C} that is smaller than the maximal heat transfer coefficient of the uncoated tubes h_{O} and larger than the minimal acceptable heat transfer coefficient hₘ (which requires cleaning the tubes from scale to retain acceptable overall efficiency). The coating, though reducing the maximal heat transfer coefficient, lengthens the time between subsequent cleaning treatment, and so increases the overall efficiency of the evaporator.

Coating (185) may be carried out after forming the tubes, and may be of variable thickness, especially when coated upon corrugated tubes. The coating may be carried out by any known method, such as electrolytic oxidation, micro arc oxidation, anodization, deposition, and so on.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment. Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention.

1-33. (canceled)

34. An evaporator comprising a plurality of horizontal, vertically elongated tubes arranged to support a vertical film of saline water, and to evaporate water from the film by heat transfer from a condensate film of condensing vapor within the tubes, characterized in that: the horizontal tubes are vertically and circumferentially corrugated in at least a specified outer profile comprising alternating outer ridges and grooves on an outer face of the tubes, the specified outer profile selected to thin the film on the outer ridges to enhance heat transfer therethrough and evaporation therefrom.

35. The evaporator according to claim 34, wherein the horizontal tubes are vertically and circumferentially corrugated in at least a specified inner profile comprising alternating inner ridges and grooves on an inner face of the tubes, the specified inner profile selected to thin the condensate film on the inner ridges to enhance heat transfer therethrough and condensation thereupon, or wherein the specified outer profile is congruent to the specified inner profile.

36. The evaporator according to claim 34, wherein at least one of: the outer profile and the inner profile, is trapezoidal, or wherein at least one of: the outer ridges and the inner ridges, is trapezoidal with convex sides, or, wherein at least one of: the outer ridges and the inner ridges, has flat or convex tops which are angular on their sides, wherein the angles ridges are shaped to control film characteristics.

37. The evaporator according to claim 36, wherein for both specified inner and outer profiles:
a horizontal distance between sequential grooves is 3.2 times (±10%) a tube wall thickness, and
a depth of the grooves is a fifth (±10%) of the horizontal distance between sequential grooves.

38. The evaporator according to claim 37, wherein the tube wall thickness is between 0.7 and 1.6 mm.

39. The evaporator according to claim 35, wherein the tubes are produced from planar corrugated sheet, and/or wherein the tubes are oval, and/or wherein the tubes have vertical parallel sides and rounded ends.

40. The evaporator according to claim 34, wherein the tubes are coated with an outer anti-corrosion coating, the anti-corrosion coating being one of: ceramic, an oxide layer, or aluminum oxide generated by micro-arc oxidation on aluminum tubes and/or wherein a thickness of the outer coating is between 5% and 0.5% of a wall thickness of the tubes.

41. The evaporator according to claim 40, wherein the tubes are made of at least one of: aluminum, magnesium, an aluminum alloy, and a magnesium alloy.

42. The evaporator according to claim 34, further comprising a surfactant unit arranged to add a surface active agent to the saline water to control the film thickness on the tubes.

43. A method of enhancing heat transfer across horizontal evaporator tubes which are vertically elongated, the method comprising corrugating an outer face of the tubes in at least a specified outer profile comprising alternating outer ridges and grooves on an outer face of the tubes, to thin a falling water film on at least part of the outer face, to increase heat transfer across the thinned film.

44. The method according to claim 43, further comprising corrugating an inner face of the tubes to thin a falling condensate film on at least part of the inner face, to increase heat transfer across the thinned condensate film, and/or further comprising flattening corrugation ridges to thin the corresponding film supported thereupon.

45. The method according to claim 44, wherein the corrugating of the outer face and of the inner face are carried out alternately, to yield a correspondence between ridges on the outer face and grooves on the inner face, and between ridges of the inner face and grooves on the outer face.

46. The method according to claim 45, wherein the corrugating is carried out by two opposing cogs to form planar corrugated sheets, and further comprising folding the sheets to generate the tubes, to yield elongated tubes with parallel planar faces.

47. The method according to claim 46, wherein the corrugations are selected to yield a horizontal distance between sequential grooves that is 3.2 times (±10%) a tube wall thickness, and a depth of the grooves is a fifth (±10%) of the horizontal distance between sequential grooves.

48. The method according to claim 44, further comprising coating the outer face of the tubes by an anti corrosive coating.

49. The method according to claim 48, wherein the coating is carried out by an oxidative treatment.

50. An evaporator comprising a plurality of tubes arranged to support a vertical film of saline water, and to evaporate water from the film by heat transfer from a condensate film of condensing vapor within the tubes, the tubes having a heat transfer coefficient h_{O} that deteriorates to a heat transfer coefficient hₘ as a result of scaling, wherein reaching hₘ requires cleaning the tubes from the scaling after a period T_{O}, the evaporator characterized in that the tubes comprise an outer coating having a heat transfer coefficient h_{C} larger than hₘ and smaller than h_{O}, the outer coating selected to increase a cleaning period to T_{C} larger than T_{O}.

51. The evaporator according to claim 50, wherein a thickness of the outer coating is between 5% and 0.5% of a wall thickness of the tubes.

52. The evaporator according to claim 51, wherein the outer coating comprises aluminum oxide generated by micro-arc oxidation on aluminum tubes and/or wherein the outer coating is an oxidized layer.

53. The evaporator according to claim 52, wherein the tubes are made of at least one of: aluminum, magnesium, an aluminum alloy, and a magnesium alloy.
